(19) United States
(12) Patent Application Publication
(10) Pub. No.: US 2021/0033754 A1
(43) Pub. Date: Feb. 4, 2021

(54) OPTICAL BAFFLE

(71) Applicant: Blue Canyon Technologies Inc., Lafayette, CO (US)

(72) Inventors: Stephen STEG, Erie, CO (US); Edward RIEDEL, Boulder, CO (US)

(73) Assignee: Blue Canyon Technologies Inc., Lafayette, CO (US)

(21) Appl. No.: 16/947,321

(22) Filed: Jul. 28, 2020

Related U.S. Application Data
(60) Provisional application No. 62/881,599, filed on Aug. 1, 2019.

(51) Int. Cl. G02B 5/00; G02B 1/00

(52) U.S. Cl. CPC G02B 5/003; G01S 3/7867; G02B 1/00

(57) ABSTRACT

An optical baffle is provided that maximizes light reflection and absorption and, thus, enables a spacecraft camera to capture images of extremely faint objects, such as stars, while illuminated by a very bright source, such as the sun. The optical baffle may be manufactured by additive manufacturing techniques and unique materials to create unique geometry and very absorbent surfaces to trap light.

This application claims the benefit of U.S. Provisional Patent Application Ser. No. 62/881,599, filed Aug. 1, 2019, the entirety of which is incorporated by reference herein.

### FIELD OF THE INVENTION

Embodiments of the present invention are generally related to light-absorbing baffles that minimize excess light exposure on star tracker detectors and telescope lenses.

### BACKGROUND OF THE INVENTION

Spacecraft commonly employ star trackers comprising of detectors and/or cameras that capture very dim starlight signals. The signals are compared to a database pattern to determine spacecraft orientation, which is fed to an attitude control computer.

Light sources outside the Earth's atmosphere shine brightly, which can adversely affect star tracker performance. For example, the sun is substantially brighter than tracked stars and, thus, stray light from the sun can overwhelm light detectors and drown out the very faint starlight. If the star images are overwhelmed or otherwise polluted with this “glow,” the spacecraft will no longer be able to assess attitude accurately. Star trackers address this issue by employing light-absorbing baffles that capture as much unwanted light as possible and minimize image background noise or “counts.”

Optical baffle assemblies generally comprise a baffle segment that employs a plurality of light-absorbing vanes. Traditional optical baffles utilize many separate solid metal (e.g., aluminum) components that are machined, cut, graded, etched, media blasted, etc. to remove material to create the desired component shape and surface texture. The components are then treated with extremely black and light absorbent coatings, for example, the coatings disclosed in U.S. Pat. Nos. 4,589,972, 5,853,897, and 4,111,762 (i.e., “Martin Black”), which are incorporated by reference herein. The baffle portions are joined to form the baffle assembly. One drawback of these traditional techniques is that manufacturing baffle vanes in complex shapes is difficult and costly. Further, the baffle components must be assembled in a separate step to create an optical baffle, which is time-consuming and expensive.

Accordingly, it is a goal of some embodiments of the present invention to create an optical baffle designed to efficiently absorb or reflect unwanted light that is easier and is less costly to manufacture.

### SUMMARY OF THE INVENTION

It is one aspect of some embodiments of the present invention to provide an optical baffle that is very light absorbent. The contemplated optical baffle, which generally comprises a main body having a plurality of inwardly extending vanes, may be used in conjunction with a camera (lens and detector) to absorb bright light from outside the camera's field of view that can cause background scatter/glow and prevent the camera from working properly. The optical baffle possesses a centerline defined by the detector midpoint and the baffle's aperture midpoint. The interior wall of the baffle defines a field-of-view, wherein the vanes absorb most light entering the baffle. However, a small percentage of light will reach deeper into the baffle, continue through the lenses, and contact the detector. The baffle design of embodiments of the present invention maximizes light absorption from reflected light, so when a very bright object is in the baffle's field of view, the detector is still able to gather an acceptable amount of starlight.

The optical baffle of one embodiment of the present invention generally comprises a baffle that employs a plurality of ring-shaped vanes. The vanes create surfaces that absorb light and cast shadows. The vanes are interconnected to the inner surface of the baffle and are angled relative to the baffle wall, which is also designed to absorb light. In one embodiment, the vane angle varies along the length of the optical baffle, wherein the vanes of an upper portion that initially receive light are angled downwardly towards lower portions of the optical baffle that possesses vanes that are angled upwardly. The vanes may comprise continuous rings, discrete inwardly extending protrusions, or combination thereof. For example, embodiments of the present invention contemplate producing baffle portions and assemblies of a plurality of vanes oriented at different angles as a function of location along the baffle centerline. One of ordinary skill in the art will appreciate that star tracker baffles should be optimized to absorb direct sunlight or sunlight reflected from other surfaces, such as the Earth (e.g., oceans, snow, ice, etc.), the moon, or the spacecraft's exterior. The contemplated optical baffle achieves light absorption by using a combination of geometric shapes and light-absorbing coatings.

It is another aspect of some embodiments of the present invention to employ additive manufacturing techniques to create unique and optimized baffle shapes that are difficult or impossible to accomplish with traditional machining techniques. More specifically, embodiments of the present invention employ selective laser sintering (S.L.S.), electron beam sintering, or other additive manufacturing techniques to create baffle shapes that are optimized to absorb light. Using these techniques, vane angles can be varied from “flat,” 0-deg to “steep,” 45 deg or 60 deg, which are oriented in a positive or negative direction, such that the vane protrudes either “up” or “down” with respect to the incoming and off-axis light. The optical baffle may be manufactured of one or multiple pieces. S.L.S. techniques deposit a layer of dry metallic powder that is melted in a specific pattern with a laser to fuse the metallic powder into a predetermined shape. Successive layers of metallic particles allow the part to be 3-D printed out of metal. Laser power can be alternated between “full” and “half” power to create very small voids within the component, particularly along vane edges. The voids create tiny surface caverns that trap and absorb light, which is described in further detail below. In one embodiment, aluminum oxide and metallic aluminum particles are combined. Following laser sintering, the aluminum oxide is etched away in a strong caustic (base) solution to create voids and a roughened surface texture.

Specific methods of roughening the surface are used to create micro-cavities and pores that increase light absorption. Again, the laser sintering media is typically a metallic power deposited layer by layer and heated with a laser to build the optical baffle. During the layer-by-layer manufacturing process, the width and/or thickness of each layer can be varied, resulting in a very rough final surface that includes many “micro-baffles.” The micro-baffles comprise small surface ledges created by varying the laser position during the S.L.S. process. Laser power may also be changed to vary between the states of “fusing” metal and “burning/cutting” metal, to create micro-voids and pits along the surfaces. The laser settings can also be varied to create internal voids within the laser-sintered component. For example, voids of up to 40-50% of the density of the part can be achieved while maintaining adequate strength and providing desirable weight reduction.

Small ceramic particles may also be embedded within the metal powder to create a “metal matrix composite” with improved mechanical properties (e.g., strength, stiffness, etc.). Accordingly, some embodiments of the present invention include embedded ceramic particles, such as aluminum oxide (Al₂O₃) within the laser-sintered structure. After the part is manufactured, it is etched with a caustic solution (e.g., a strong base) that dissolves the Al₂O₃ particles, which leaves pits/valleys. After etching, the part is anodized with sulfuric acid, followed by a black dying and a sealing process. One of skill in the art will appreciate that other anodizing processes may be used without departing from the scope of the invention. In addition, other plating, painting, and coating processes for creating a black light absorbent surface may be employed. The sealing process may include a vacuum drying, followed by a hydrogen fluoride treatment.

Although the above describes improved baffles for star trackers, the concepts described herein would work equally well in other optical instruments, both terrestrial and space-born. For example, telescopes, spectrometers, and optical sensors could all benefit from the concepts discussed herein. Some embodiments could also be used for infrared radiator and absorber surfaces that benefit by having very rough, light-absorbing surfaces.

Thus, it is one aspect of embodiments of the present invention to provide a device for gathering light signals, comprising: a first segment defined by a proximal end and a distal end spaced from the proximal end, which defines the length of the first segment, the first segment also having an inner surface with a plurality of vanes extending into an interior volume of the first segment, wherein each of the plurality of vanes are interconnected to the inner surface at a vane angle; a second segment interconnected proximal end to the second surface of the first segment; a detector situated within the second segment adjacent; and at least one lens situated between the first segment and the detector.

It is yet another aspect of embodiments of the present invention to provide a device for gathering light signals, comprising: a first segment defined by a proximal end and a distal end spaced from the proximal end, which defines the length of the first segment, the first segment also having an inner surface with a plurality of vanes extending therefrom, wherein each of the plurality of vanes are interconnected to the inner surface at a vane angle; a second segment interconnected to the proximal end of the first segment; a detector situated within the second segment; at least one lens situated within the second segment between the detector and the first segment; wherein each vane of the plurality thereof comprises a ring with a first, outer end interconnected to the inner surface of the first segment and a second, inner end, each vane further comprising an upper surface that generally faces the distal end of the first segment and a lower surface that generally faces the second segment, and wherein the vane angle is defined as the angle between the lower surface of each vane and a planar surface that normal to a longitudinal axis of the first segment; and wherein the vane angle changes from one vane to the next vane as a function of a vane's location relative to the proximal end of the first segment.

The Summary of the Invention is neither intended nor should it be construed as being representative of the full extent and scope of the present invention. That is, these and other aspects and advantages will be apparent from the disclosure of the invention(s) described herein. Further, the above-described embodiments, aspects, objectives, and configurations are neither complete nor exhaustive. As will be appreciated, other embodiments of the invention are possible using, alone or in combination, one or more of the features set forth above or described below. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description, and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present invention are possible utilizing, alone or in combination, as set forth above and/or described in the accompanying figures and/or in the description hereinbelow.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and drawing figures are to be understood as being approximations that may be modified in all instances as required for a particular application of the novel assembly and method described herein.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description and in the appended drawing figures.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, explain the principles of these inventions.

FIG. 1 is a side elevation view of an optical baffle of one embodiment of the present invention interconnected to a lens barrel;

FIG. 2 is a top plan view of FIG. 1;

FIG. 3 is a cross-sectional view of FIG. 1;

FIG. 4 is a detailed view of FIG. 3; and

FIG. 5 is another detailed view of FIG. 3.

The following component list and associated numbering found in the drawings is provided to assist in the understanding of one embodiment of the present invention:

| # | Component |
|---|---|
| 2 | Optical Baffle |
| 6 | Detector |
| 10 | Lens barrel |
| 14 | Lens |
| 16 | Proximal end |
| 18 | Distal end |
| 20 | Aperture |
| 22 | Light |
| 26 | Wall |
| 30 | Inner surface |
| 34 | Outer surface |
| 38 | Vane |
| 42 | Edge surface |
| 46 | Field of view boundary |
| 50 | First end |
| 54 | Second end |
| 58 | Horizontal plane |
| 60 | Centerline |
| 62 | Outer surface |
| 66 | Inner surface |
| 68 | Chamfer |
| 72 | Overhang |
| 76 | Edge, |

It should be understood that the drawings are not necessarily to scale. In certain instances, details which are not necessary for an understanding of the invention or which render other details difficult to perceive may have been omitted. It should be understood, of course, that the invention is not necessarily limited to the embodiments illustrated herein.

### DETAILED DESCRIPTION

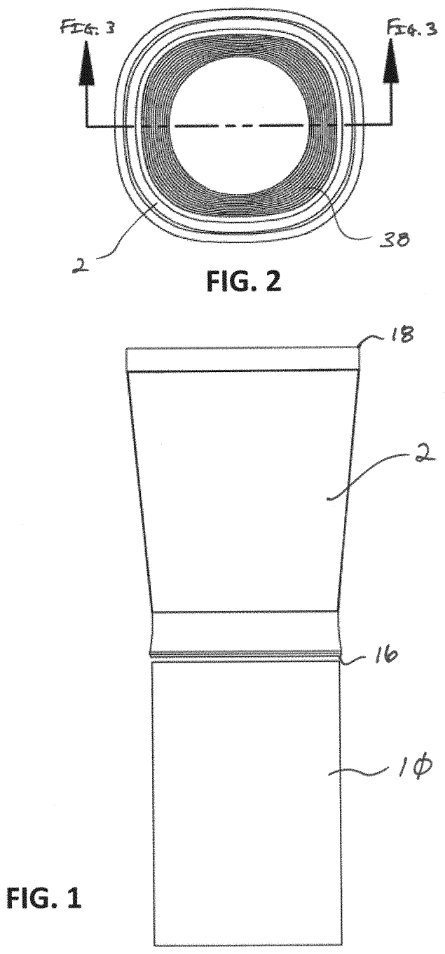

FIGS. 1-3 show an optical baffle 2 designed to minimize the amount of off-angle or bright light sensed by a detector 6. The baffle 2 is interconnected to a lens barrel 10 that houses a plurality of lenses 14. The baffle 2 of one embodiment of the present invention is frusto-conical, wherein a proximal end 16, which is interconnected to the lens barrel 10 has a smaller outer diameter then a distal end, which includes an aperture 20 that that captures light 22. The lens barrel 10 of one embodiment of the present invention accommodates three lenses 14 and the detector 6. Those of ordinary skill in the art will appreciate that the detector may be associated with a camera.

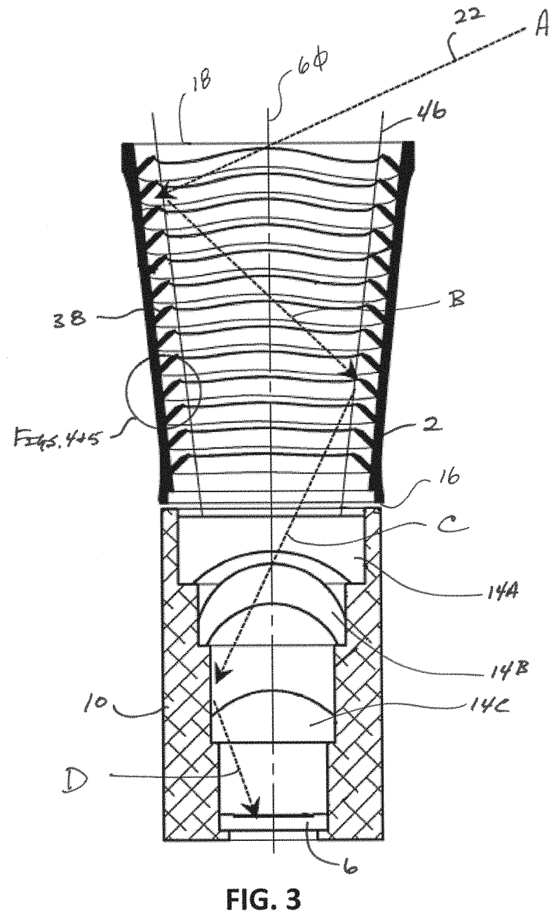

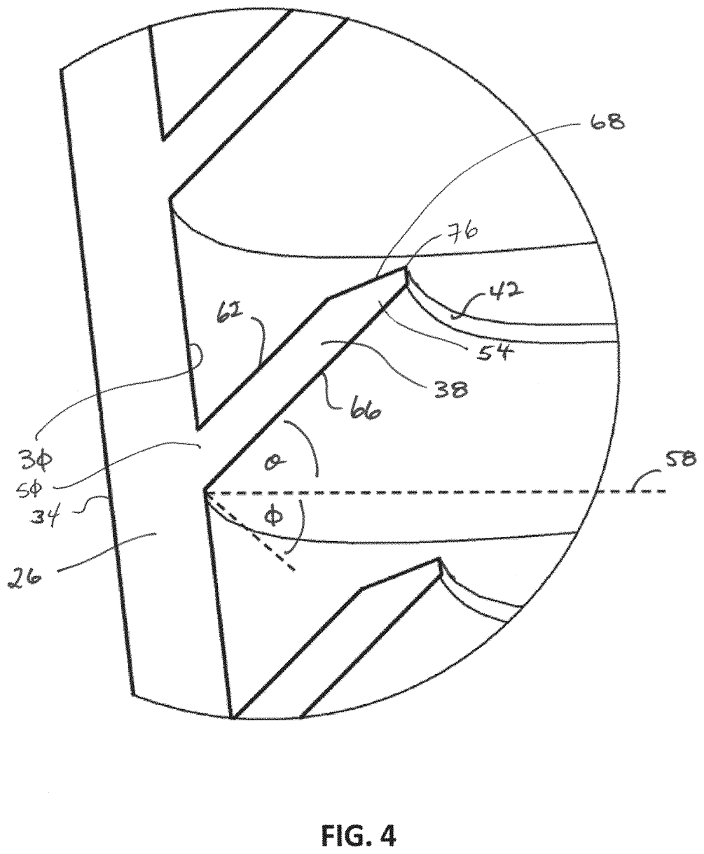

Referring now to FIGS. 3 and 4, the internal configuration of an optical baffle 2 of one embodiment of the present invention is shown. The baffle 2 generally consists of a wall 26 that has an inner surface 30 and an outer surface 34. A series of vanes 38 extend from the inner surface 30 into an interior volume of the baffle 2. Each vane ends in an edge surface 42 or a tip, which defines a field-of-view boundary 46. In operation, off-angle light 22 enters the optical baffle 2; in this example along arrow A. Thereafter, the light reflects off interior surfaces of the baffle and follows arrows B and C, and eventually contacts the detector 6. It is the goal of embodiments the present invention to minimize the amount and intensity of light that contacts the detector from off angled sources, i.e., light along arrow D. The light angles shown are for illustrative purposes only. In practice, the gathered light bounces in every direction and most of it is absorbed before striking the detector.

The vanes 38 have a first end 50, or route, interconnected to the inner surface 30 of the baffle wall 26 and a second end 54 that extends into the interior volume of the optical baffle 2. The vanes 38 are angled with respect to an imaginary horizontal plane 58 that is substantially parallel to a plane normal to the baffle centerline 60. The vane angle (0) may vary depending on the vane's location within the optical baffle 2. The vane angle, with respect to horizontal, may vary from 0° (i.e., horizontal) to a steep angle, (i.e., about 30° to 60°). The angle may be different between adjacent baffles. The ideal angle is a function of the position of the vane within the baffle. In some embodiments, vanes near the aperture have a negative angle and vanes near the lens have a positive angle.

For example, in one embodiment of the present invention, the vane angle adjacent to the distal end 18 of the optical baffle is less than that of the vanes located closer to the lens barrel 10. This feature facilitates absorbing or deflecting unwanted light, wherein the majority of unwanted light does not reach the detector 6. One of ordinary skill in the art will appreciate that the vanes may be formed in groups with the same vane angle. In addition, it should be appreciated that the vane angle (θ) may vary as a function of the distance from the distal end 18 of the optical baffle to the proximal end 16 of the optical baffle. Again, the vane angle could be negative (φ).

The vanes 38 follow the profile of the inner surface 30 of the optical baffle 2, which creates ring-shaped vanes. In one embodiment of the present invention, the interior surface of the optical baffle 2 has a generally square cross-section, as shown in FIG. 2. However, circular, semicircular, rectangular, oval, faceted (e.g., hexagonal, etc.), or triangular cross-sections are also contemplated. The second end 54 of the vanes 38 may define a plane or be noncontinuous, i.e., wavy, as shown in FIG. 3. The vanes may also be non-continuous and consist of adjacent vane segments follow the interior baffle profile.

The vanes 38 may also have a non-continuous edge 42. More specifically, as shown in FIG. 4, the edge 42 of at least one vane 38 includes an outer surface 62 and inner surface 66 that meet and define an edge 76. Here, the edge 76 is defined by the conjunction of a chamfer 68 that extends from a portion of the outer surface 62 and the edge surface 42 that extends upwardly from the inner surface 66. Depending on the vane angle, the surface provided by the chamfer 68 will generally correspond with the imaginary horizontal plane 58. As mentioned briefly above, the surfaces provided by the chamfer 68 reflect unwanted light upwardly towards the inner surface 66 of an adjacent vane 38.

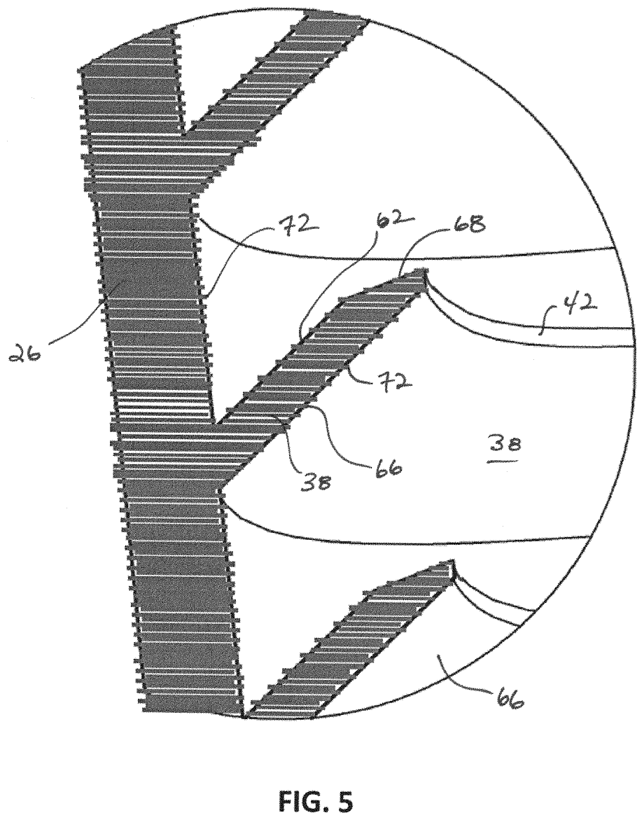

As shown in FIG. 5, the optical baffle 2 may be formed of a sintering process that creates overhangs 72, inconsistencies, or voids on the baffle's inner surface 30 and/or the vane's inner surface 30 and/or outer surface 34. The overhangs disrupt the smooth surface of the optical baffle and its vanes and create obstructions that deflect or absorb the unwanted light 22.

Exemplary characteristics of embodiments of the present invention have been described. However, to avoid unnecessarily obscuring embodiments of the present invention, the preceding description may omit several known apparatus, methods, systems, structures, and/or devices one of ordinary skill in the art would understand are commonly included with the embodiments of the present invention. Such omissions are not to be construed as a limitation of the scope of the claimed invention. Specific details are set forth to provide an understanding of some embodiments of the present invention. It should, however, be appreciated that embodiments of the present invention may be practiced in a variety of ways beyond the specific detail set forth herein.

Modifications and alterations of the various embodiments of the present invention described herein will occur to those skilled in the art. It is to be expressly understood that such modifications and alterations are within the scope and spirit of the present invention, as set forth in the following claims. Further, it is to be understood that the invention(s) described herein is not limited in its application to the details of construction and the arrangement of components set forth in the preceding description or illustrated in the drawings. That is, the embodiments of the invention described herein are capable of being practiced or of being carried out in various ways. The scope of the various embodiments described herein is indicated by the following claims rather than by the foregoing description. And all changes which come within the meaning and range of equivalency of the claims are to be embraced within their scope. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The foregoing disclosure is not intended to limit the invention to the form or forms disclosed herein. In the foregoing Detailed Description, for example, various features of the invention are grouped together in one or more embodiments for the purpose of streamlining the disclosure. This method of disclosure is not to be interpreted as reflecting an intention that the claimed inventions require more features than expressly recited. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention. Further, the embodiments of the present invention described herein include components, methods, processes, systems, and/or apparatus substantially as depicted and described herein, including various sub-combinations and subsets thereof. Accordingly, one of skill in the art will appreciate that it would be possible to provide for some features of the embodiments of the present invention without providing others. Stated differently, any one or more of the aspects, features, elements, means, or embodiments as disclosed herein may be combined with any one or more other aspects, features, elements, means, or embodiments as disclosed herein.

What is claimed is:

1. A device for gathering light signals, comprising:
a first segment defined by a proximal end and a distal end spaced from the proximal end, which defines the length of the first segment, the first segment also having an inner surface with a plurality of vanes extending into an interior volume of the first segment, wherein each of the plurality of vanes are interconnected to the inner surface at a vane angle;
a second segment interconnected proximal end to the second surface of the first segment;
a detector situated within the second segment adjacent; and
at least one lens situated between the first segment and the detector.

2. The device of claim 1, wherein the vane angle changes from one vane to the next vane as a function of a vane's location relative to the proximal end of the first segment.

3. The device of claim 1, wherein the plurality of vanes are defined by vane groups, wherein each vane in a vane group has the same vane angle.

4. The device of claim 1, wherein each vane of the plurality thereof has a rough surface texture.

5. The device of claim 1, wherein the interior surface and the plurality of vanes are coated with black anodize.

6. The device of claim 1, wherein the at least one lens comprises a first lens, a second lens, and a third lens.

7. The device of claim 1, wherein the first segment is frustoconical.

8. The device of claim 7, wherein a cross section of the first segment is generally square or rectangular.

9. The device of claim 1, wherein each vane of the plurality thereof comprises a ring with a first, outer end interconnected to the inner surface of the first segment and a second, inner end positioned within the interior volume of the first segment, each vane further comprising an upper surface that generally faces the distal end of the first segment and a lower surface that generally faces the second segment, and wherein the vane angle is defined as the angle between the lower surface of each vane and a corresponding imaginary planar surface that is normal to a longitudinal axis of the first segment.

10. The device of claim 9, wherein at least one vane angle is negative, wherein the lower surface is directed towards the second segment.

11. The device of claim 9, wherein the second end of each vane comprises a non-planar outer extent defined by the conjunction of the upper surface and lower surface of each vane.

12. The device of claim 9, wherein each vane of the plurality thereof includes cavities on the upper and lower surface thereof, and wherein the plurality of vanes possess internal voids.

13. The device of claim 9, wherein the upper surface of each vane includes a downward slopping portion, and the lower surface of each vane includes an upward slopping portion that meet to define an outer extent of each vane.

14. The device of claim 9, wherein the plurality of vanes is manufactured by a laser sintering process, whereby the first segment and the plurality of vanes are formed of discrete material layers.

15. The device of claim 14, wherein the layers are varied in width, wherein the inner surface of the first segment, the upper surfaces, and the lower surfaces of the plurality of vanes is consist of microscopic overhangs.

16. The device of claim 14, wherein the first segment and plurality of vanes are made of aluminum (Al) particles blended with aluminum oxide (Al₂O₃) particles in a concentration of between about 6% and 50%, wherein in the Al₂O₃ particles are later removed by etching.

17. A device for gathering light signals, comprising:
a first segment defined by a proximal end and a distal end spaced from the proximal end, which defines the length of the first segment, the first segment also having an inner surface with a plurality of vanes extending therefrom, wherein each of the plurality of vanes are interconnected to the inner surface at a vane angle;
a second segment interconnected to the proximal end of the first segment;
a detector situated within the second segment;
at least one lens situated within the second segment between the detector and the first segment;
wherein each vane of the plurality thereof comprises a ring with a first, outer end interconnected to the inner surface of the first segment and a second, inner end, each vane further comprising an upper surface that generally faces the distal end of the first segment and a lower surface that generally faces the second segment, and wherein the vane angle is defined as the angle between the lower surface of each vane and a planar surface that normal to a longitudinal axis of the first segment; and
wherein the vane angle changes from one vane to the next vane as a function of a vane's location relative to the proximal end of the first segment.

18. The device of claim 17, wherein at least one vane angle is negative, wherein the lower surface is directed towards the second segment.

19. The device of claim 17, wherein the upper surface of each vane includes a downward slopping portion, and the lower surface of each vane includes an upward slopping portion that meet to define an outer extent of each vane.

20. The device of claim 17, wherein the plurality of vanes is manufactured by a laser sintering process, whereby the first segment and the plurality of vanes are formed of discrete material layers, and wherein the layers are varied in width, wherein the inner surface of the first segment, the upper surfaces, and the lower surfaces of the plurality of vanes consist of microscopic overhangs.
